(19) United States
(12) Patent Application Publication
(10) Pub. No.: US 2006/0179275 A1
(43) Pub. Date: Aug. 10, 2006

(54) Methods and apparatus for processing instructions in a multi-processor system

(76) Inventor: Takeshi Yamazaki, Kanagawa (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/053,487

(22) Filed: Feb. 8, 2005

(51) Int. Cl. G06F 9/40

(52) U.S. Cl. 712/205; 712/216

(57) ABSTRACT

Methods and apparatus provide for transferring blocks of data between a shared memory and one or more of a plurality of parallel processors, each processor including a local memory; executing one or more programs within the local memory of one or more of the processors, wherein the one or more programs are coded such that they do not rely on data caching within the processor; and buffering not more than about three instructions from any local memory in any instruction buffer of any processor, wherein the instruction buffer of each processor is adapted to process instructions with substantially maximal efficiency when the one or more programs are coded such that they do not rely on data caching within the processor.

### BACKGROUND

The present invention relates to methods and apparatus for processing instructions in multi-processing system.

Real-time, multimedia applications are becoming increasingly important. These applications require extremely fast processing speeds, such as many thousands of megabits of data per second. While some processing systems employ a single processor to achieve fast processing speeds, others are implemented utilizing multi-processor architectures. In multi-processor systems, a plurality of sub-processors can operate in parallel (or at least in concert) to achieve desired processing results.

In recent years, there has been an insatiable desire for faster computer processing data throughputs because cutting-edge computer applications are becoming more and more complex, and are placing ever increasing demands on processing systems. Graphics applications are among those that place the highest demands on a processing system because they require such vast numbers of data accesses, data computations, and data manipulations in relatively short periods of time to achieve desirable visual results.

Thus, in the design of a microprocessor, instruction throughput, i.e., the number of instructions executed per second, is of some importance. The number of instructions executed per second may be increased by various means. For example, increasing instruction throughput may be achieved by increasing the frequency at which the microprocessor operates. Increased operating frequency, however, is limited by fabrication techniques and also results in the generation of additional heat. Thus, some microprocessor designs are focusing on increasing the instruction throughput by using design techniques which increase the average number of instructions executed per clock cycle period. One such technique for increasing instruction throughput is pipelining, which dictates that each instruction is segmented and flows through the microprocessor into several portions, each of which can be handled by a separate stage in the pipeline. Pipelining increases the speed of a microprocessor by overlapping multiple instructions in execution. For example, if each instruction could be executed in six stages, and each stage required one clock cycle to perform its function, six separate instructions could be simultaneously executed (each executing in a separate stage of the pipeline) such that one instruction was completed on each clock cycle. In this scenario, the pipelined architecture would have an instruction throughput which was six times greater than the non-pipelined architecture, which could complete one instruction every six clock cycles.

A second technique for increasing the speed of a microprocessor involves designing the processor as a superscalar. In a superscalar architecture, more than one instruction is issued per clock cycle. If no instructions are dependent upon other instructions in the flow, the increase in instruction throughput is proportional to the degree of scaleability. Thus, if an architecture is of a degree of two (meaning that two instructions are issued each clock cycle), then the instruction throughput in the machine is doubled.

A microprocessor may be both superpipelined (an instruction pipeline with many stages) and a superscalar to achieve a high instruction throughput. In practice, however, the instructions are not usually executed in a given number of pipeline stages without interdependencies. Rather, instructions usually have varying resource requirements that create interruptions in the flow through the instruction pipeline. Further, the instructions typically have interdependencies; for example, an instruction which reads the value of a register may be dependent on a previous instruction that writes the value to that same register. In this scenario, the second instruction cannot execute until the first instruction has completed its write to the register.

Consequently, while superpipelining and superscalar techniques can increase the throughput of a microprocessor, the instruction throughput is highly dependent upon the implementation of the superpipelined, superscalar architecture. The efficiency of a superpipelined, superscalar processing system may be diminished as dependencies, or other factors, cause various stages to be inactive during operation of the microprocessor.

A conventional processing pipeline includes an instruction fetch stage, an instruction decode stage, a dependency checking stage, an instruction issue stage and an execution stage. In the well known Pentium processor, an instruction buffer is employed to queue up the instructions after the instruction fetch stage. The instruction buffer is designed to queue a plurality of instructions (a relatively large number of instructions), where the instructions may be taken out of the buffer in any order for subsequent decoding, dependency checking, issuing and executing. While this approach is in wide use and has achieved wide acceptance, two factors impact the level of processing power that may be obtained. First, the relatively large size of the instruction buffer requires testing a significant number of possible instruction dependencies before issuing instructions. Second, if a cache miss or a branch instruction occurs, the entire contents of the instruction buffer must be purged and refreshed. Thus, under some circumstances, the conventional instruction buffer approach is undesirable.

### SUMMARY OF THE INVENTION

The present invention provides for an improved technique of implementing a processing pipeline which minimizes the disadvantageous loss of processing power resulting from conventional processing architectures. First, the invention employs a relatively small instruction buffer for queuing about two or three instructions, which are taken from the buffer two (or three) at a time for simultaneous decoding, and dependency checking. This advantageously results in testing a relatively small number of possible instruction dependencies. Second, the invention employs a multi-processor system having a main processor and a plurality of sub-processors sharing a common system memory. Each sub-processor has a preferably non-cached local memory in which to execute instructions, while the main processor employs an L2 cache memory. As the sub-processors do not employ a cache memory, and the local memory is relatively small compared to the system memory, the burden is on the programmer to minimize memory transfers between the system memory and the local memories during program execution (such as by thoughtful data organization within the system memory, use of branch hint techniques, etc.). The combination of the instruction buffer implementation, the multi-processor system implementation, and the programming techniques results in significant processing power as compared with prior art techniques.

In accordance with one or more features described herein, an apparatus includes: a plurality of parallel processors capable of operative communication with a shared memory, each processor including: a local memory, and an instruction pipeline including an instruction buffer of not larger than about three registers coupled to the local memory, and instruction dependency check circuit operable to test dependencies among instructions within the pipeline. Each processor may be operable to transfer blocks of data between the shared memory and its local memory for execution of one or more programs within the local memory.

The instruction buffer and dependency check circuit of each processor may be adapted to process instructions with substantially maximal efficiency when the one or more programs are coded such that they do not rely on data caching within the processor. In one or more alternative embodiments, the number of registers defining the size of the instruction buffer may be minimized as a function of the one or more programs being coded such that they do not rely on data caching within the processor.

Preferably, the instruction buffer is not larger than about two or three registers and all the instructions leave the registers of the instruction buffer as a group.

The instruction pipeline may also include an instruction decode circuit coupled to the instruction buffer, wherein the instruction decode circuit is operable to simultaneously decode a number of instructions equal to the number of registers of the instruction buffer.

The instruction dependency check circuit is preferably operable to check the dependency of the instructions in the instruction pipeline in parallel.

Each processor is preferably operable to transfer the blocks of data between the shared memory and its local memory using direct memory accesses. While each processor is capable of executing the one or more programs within its local memory, each processor is not capable of executing the one or more programs within the shared memory.

Preferably, the processors and associated local memories are disposed on a common semiconductor substrate. The shared memory is preferably coupled to the processors over a bus. In one or more embodiments, the processors, associated local memories, and the shared memory are disposed on a common semiconductor substrate.

In one or more alternative embodiments, the apparatus may also include: a main processor operatively coupled to the processors and capable of being coupled to the shared memory; and a hardware cache memory associated with the main processor and operable cache data obtained from at least one of the shared memory and one or more of the local memories of the processors, wherein the main processor is operable to manage the processors.

In accordance with one or more further features described herein, a method includes: transferring blocks of data between a shared memory and one or more of a plurality of parallel processors, each processor including a local memory; executing one or more programs within the local memory of one or more of the processors, wherein the one or more programs are coded such that they do not rely on data caching within the processor; and buffering not more than about three instructions from any local memory in any instruction buffer of any processor. The instruction buffer of each processor may be adapted to process instructions with substantially maximal efficiency when the one or more programs are coded such that they do not rely on data caching within the processor.

The method may alternatively or additionally include: transferring blocks of data between a shared memory and one or more of a plurality of parallel processors, each processor including a local memory; transferring blocks of data between the shared memory and at least one main processor, the at least one main processor being coupled to a hardware cache memory for storing the blocks of data; executing one or more programs within the local memory of one or more of the processors, wherein the one or more programs are coded such that they do not rely on data caching within the processor; and buffering not more than about three instructions from any local memory in any instruction buffer of any processor.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a diagram illustrating the structure of a multi-processing system having two or more sub-processors accordance with one or more aspects of the present invention;

FIG. 2 is a diagram illustrating a pipeline structure of one or more of the processors of the processing system of FIG. 1;

FIG. 3 is a flow diagram illustrating process steps that may be carried out by the processing system of FIG. 1 in accordance with one or more aspects of the present invention;

FIG. 4 is a diagram illustrating a preferred processor element (PE) that may be used to implement one or more further aspects of the present invention;

FIG. 5 is a diagram illustrating the structure of an exemplary sub-processing unit (SPU) of the system of FIG. 4 in accordance with one or more further aspects of the present invention; and

FIG. 6 is a diagram illustrating the structure of an exemplary processing unit (PU) of the system of FIG. 4 in accordance with one or more further aspects of the present invention.

### DETAILED DESCRIPTION OF THE PRESENT INVENTION

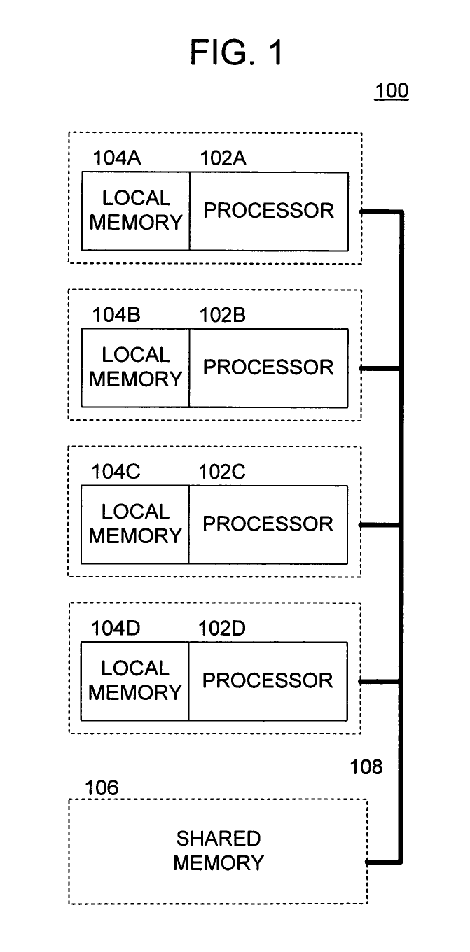

With reference to the drawings, wherein like numerals indicate like elements, there is shown in FIG. 1 a processing system 100 suitable for implementing one or more features of the present invention. For the purposes of brevity and clarity, the block diagram of FIG. 1 will be referred to and described herein as illustrating an apparatus 100, it being understood, however, that the description may readily be applied to various aspects of a method with equal force.

The multi-processing system 100 includes a plurality of processors 102A-D, associated local memories 104A-D, and a shared memory 106 interconnected by way of a bus 108. The shared memory may also be referred to herein as a main memory or system memory. Although four processors 102 are illustrated by way of example, any number may be utilized without departing from the spirit and scope of the present invention. Each of the processors 102 may be of similar construction or of differing construction. The processors 102 may be implemented utilizing any of the known technologies that are capable of requesting data from the system memory 106, and manipulating the data to achieve a desirable result. For example, the processors 102 may be implemented using any of the known microprocessors that are capable of executing software and/or firmware, including standard microprocessors, distributed microprocessors, etc. By way of example, one or more of the processors 102 may be a graphics processor that is capable of requesting and manipulating data, such as pixel data, including gray scale information, color information, texture data, polygonal information, video frame information, etc.

The local memories 104 are preferably located on the same chip (same semiconductor substrate) as their respective processors 102; however, the local memories 104 are preferably not traditional hardware cache memories in that there are no on-chip or off-chip hardware cache circuits, cache registers, cache memory controllers, etc. to implement a hardware cache memory function. As on chip space is often limited, the size of the local memories 104 may be much smaller than the system memory 106.

The processors 102 preferably provide data access requests to copy data (which may include program data) from the system memory 106 over the bus 108 into their respective local memories 104 for program execution and data manipulation. The mechanism for facilitating data access may be implemented utilizing any of the known techniques, such as direct memory access (DMA) techniques. The system memory 106 is preferably a dynamic random access memory (DRAM) coupled to the processors 102 through a high bandwidth memory connection (not shown). Although the system memory 106 is preferably a DRAM, the memory 106 may be implemented using other means, e.g., a static random access memory (SRAM), a magnetic random access memory (MRAM), an optical memory, a holographic memory, etc.

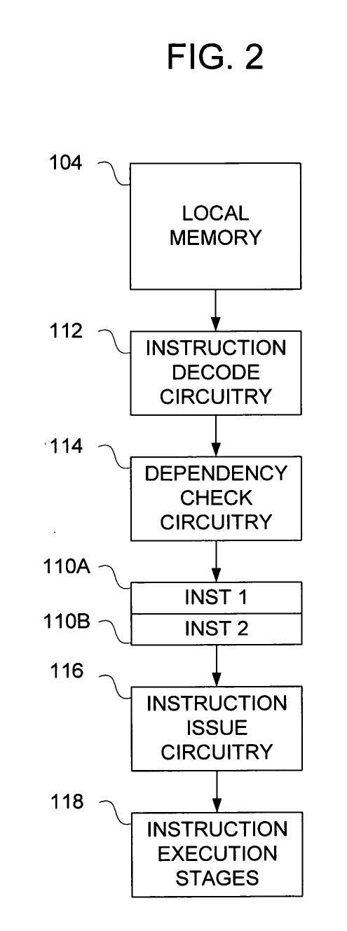

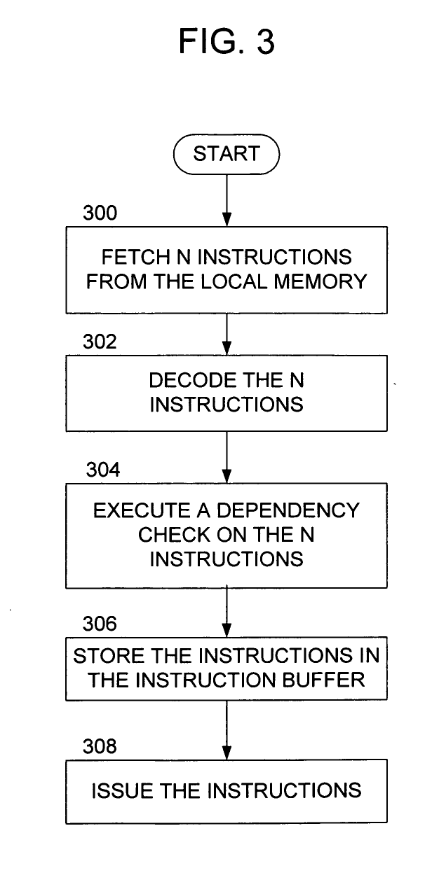

With reference to FIGS. 2-3, each processor 102 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processors 102 may include instruction decode circuitry 112, dependency check circuitry 114, an instruction buffer 110, instruction issue circuitry 116, and execution stages 118.

After an instruction fetch (action 300), the decode circuitry 112 breaks down the instructions and generates logical micro-operations that perform the function of the corresponding instruction. For example, the logical micro-operations may specify arithmetic and logical operations, load and store operations to the local memory 104, register source operands and/or immediate data operands. The decode circuitry 112 may also indicate which resources the instruction uses, such as target register addresses, structural resources, function units and/or busses. The decode circuitry 112 may also supply information indicating the instruction pipeline stages in which the resources are required. The instruction decode circuitry 112 is preferably operable to substantially simultaneously decode a number of instructions equal to the number of registers of the instruction buffer 110 (action 302).

The dependency check circuitry 114 includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously (action 304). The number of comparisons (e.g., exclusive OR operations) performed by the dependency check circuitry 114 for a given instruction is a function of the number of operands in the given instruction multiplied by the number of instructions which may be concurrently dispatched, further multiplied by the number of instructions which may be stored in the instruction buffer 110. When the number of instructions storable in the instruction buffer is large, the number of comparisons for performing dependency checking is also large. Thus, the total number of comparisons that should be provided for is the number of possible operands of any instruction multiplied by the number of instructions which may be dispatched, further multiplied by the number of instructions which may be stored in the instruction buffer 110. As the number of instructions storable in the instruction buffer increases, the amount of circuitry employed to perform the comparisons increases dramatically, which is undesirable. Thus, it is preferred that the size of the instruction buffer is also minimized for this reason.

The instruction buffer 110 preferably includes a plurality of registers 110A-B that are coupled to the dependency check circuit 114 and operable to temporarily store instructions (action 306). The instruction buffer 110 operates such that all the instructions leave the registers 110A-B as a group, i.e., substantially simultaneously. It is preferred that the instruction buffer is of a size not larger than about two or three registers, or more generally, that the number of registers defining the size of the instruction buffer is minimized. As will be discussed in more detail below, advantageous results are obtained when the size of the instruction buffer 110 is minimized in accordance with corresponding actions taken during application programming coding, such as coding the programs such that they do not rely on data caching within the processor 102.

The instruction issue circuitry 116 is operable to issue the instructions to the execution stages of the processor 102 (action 308). Preferably, the processor 102 is of a superscalar architecture, such that more than one instruction is issued per clock cycle and the speed of the processor is correspondingly increased. If no instructions are dependent upon other instructions in the flow, the increase in instruction throughput should be proportional to the degree to which the instruction issue circuitry 116 simultaneously issues the instructions. The processors 102 are preferably operate as superscalars to a degree corresponding to the number of simultaneous instruction dispatches from the instruction buffer 110, such as between 2 and 3 (meaning that two or three instructions are issued each clock cycle).

As the number of instructions in the instruction buffer 110 are minimized, vis-à-vis a relatively small number of registers 110A-B therein (such as two registers), the dependency check circuitry 114 may also be minimized, thereby reducing the quantum of logic needed to perform the dependency check. This permits each processor 102 to process instructions with substantially maximal efficiency when the one or more programs are coded such that they do not rely on data caching within the processor. Indeed, each processor 102 is operable to transfer blocks of data between the shared memory 106 and its local memory 104 for execution programs within the local memory 104, but the processors 102 are not capable of executing the programs in the shared memory 106. Thus, the efficiency with which the instructions are transferred from the shared memory 106 and executed within the processing pipeline is enhanced when the programmer codes the programs to take advantage of block data transfers without data caching in the local memories 104.

In an alternative embodiment, the system 100 may include a main processor (not shown) operatively coupled to the other processors 102 and capable of being coupled to the shared memory 106 over the bus 108. The main processor may schedule and orchestrate the processing of data by the other processors 102. Unlike the other processors 102, however, the main processor may be coupled to a hardware cache memory, which is operable cache data obtained from at least one of the shared memory 106 and one or more of the local memories 104 of the processors 102. The main processor may provide data access requests to copy data (which may include program data) from the system memory 106 over the bus 108 into the cache memory for program execution and data manipulation utilizing any of the known techniques, such as DMA techniques.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multi-processing computer system are constructed from a common computing module (or cell). This common computing module has a consistent structure and preferably employs the same instruction set architecture. The multi-processing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

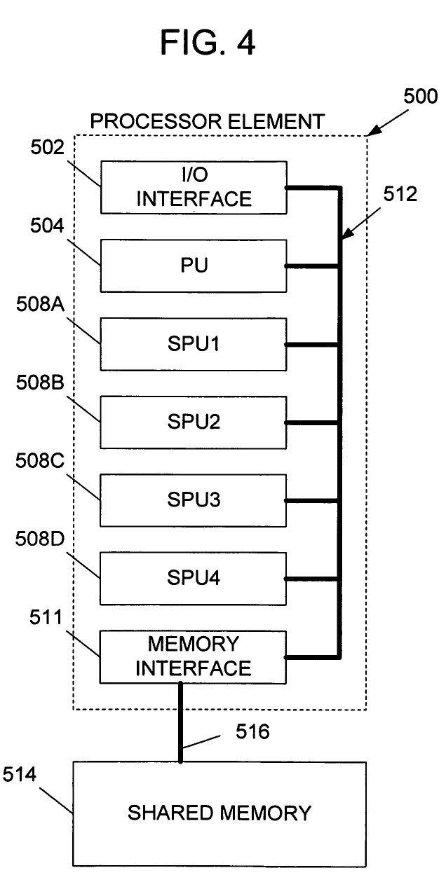

With reference to FIG. 4, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

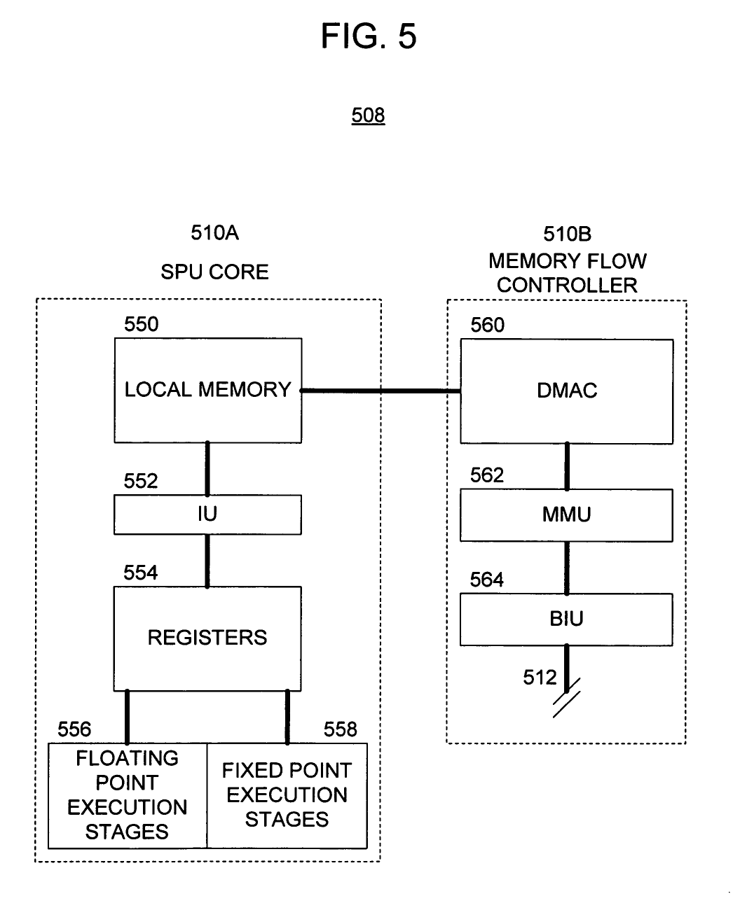

FIG. 5 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 2⁶⁴ bytes of effective address space with 4K-, 64K-, 1 M-, and 16 M-byte page sizes and 256 MB segment sizes. Preferably, the MMU 562 is operable to support up to 2⁶⁵ bytes of virtual memory, and 2⁴² bytes (4 TeraBytes) of physical memory for DMA commands. The hardware of the MMU 562 may include an 8-entry, fully associative SLB, a 256-entry, 4 way set associative TLB, and a 4×4 Replacement Management. Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

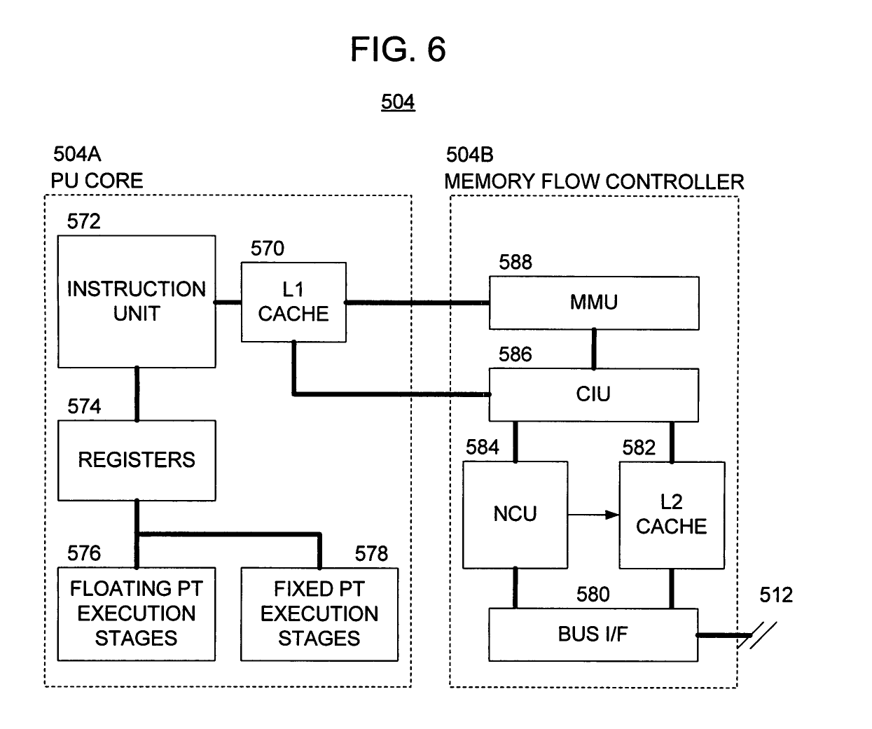

FIG. 6 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus, comprising:
a plurality of parallel processors capable of operative communication with a shared memory, each processor including: a local memory, and an instruction pipeline including an instruction buffer of not larger than about three registers coupled to the local memory, and instruction dependency check circuit operable to test dependencies among instructions within the pipeline, wherein:
each processor is operable to transfer blocks of data between the shared memory and its local memory for execution of one or more programs within the local memory, and
the instruction buffer and dependency check circuit of each processor are adapted to process instructions with substantially maximal efficiency when the one or more programs are coded such that they do not rely on data caching within the processor.

2. The apparatus of claim 1, wherein all the instructions leave the registers of the instruction buffer as a group.

3. The apparatus of claim 1, wherein the instruction pipeline further includes an instruction decode circuit coupled to the instruction buffer.

4. The apparatus of claim 3, wherein the instruction decode circuit is operable to simultaneously decode a number of instructions equal to the number of registers of the instruction buffer.

5. The apparatus of claim 1, wherein the instruction dependency check circuit is operable to check the dependency of the instructions in the instruction pipeline in parallel.

6. The apparatus of claim 1, wherein each processor is operable to transfer the blocks of data between the shared memory and its local memory using direct memory accesses.

7. The apparatus of claim 1, wherein each processor is capable of executing the one or more programs within its local memory, but each processor is not capable of executing the one or more programs within the shared memory.

8. The apparatus of claim 1, wherein the processors and associated local memories are disposed on a common semiconductor substrate.

9. The apparatus of claim 8, further comprising the shared memory coupled to the processors over a bus.

10. The apparatus of claim 9, wherein the processors, associated local memories, and the shared memory are disposed on a common semiconductor substrate.

11. The apparatus of claim 1, wherein the local memory is not a hardware cache memory.

12. An apparatus, comprising:
a plurality of parallel processors capable of operative communication with a shared memory, each processor including: a local memory, and an instruction pipeline including an instruction buffer coupled to the local memory, and instruction dependency check circuitry operable to test dependencies among instructions within the pipeline, wherein:
each processor is operable to transfer blocks of data between the shared memory and its local memory for execution of one or more programs within the local memory, and
a number of registers defining a size of the instruction buffer is minimized as a function of the one or more programs being coded such that they do not rely on data caching within the processor.

13. The apparatus of claim 12, wherein the instruction buffer is not larger than about three registers.

14. The apparatus of claim 13, wherein the instruction buffer is not larger than about two registers.

15. The apparatus of claim 14, wherein the instruction buffer includes two registers.

16. The apparatus of claim 15, further comprising:
a main processor operatively coupled to the processors and capable of being coupled to the shared memory; and
a hardware cache memory associated with the main processor and operable cache data obtained from at least one of the shared memory and one or more of the local memories of the processors.

17. The apparatus of claim 16, wherein the main processor is operable to manage the processors.

18. The apparatus of claim 12, wherein the local memory is not a hardware cache memory.

19. An apparatus, comprising:
a plurality of parallel processors capable of operative communication with a shared memory, each processor including: a local memory, and an instruction pipeline including an instruction buffer of not larger than about three registers coupled to the local memory, and instruction dependency check circuit operable to test dependencies among instructions within the pipeline;
a main processor operatively coupled to the processors and capable of being coupled to the shared memory; and
a hardware cache memory associated with the main processor and operable cache data obtained from at least one of the shared memory and one or more of the local memories of the processors, wherein:
each processor is operable to transfer blocks of data between the shared memory and its local memory for execution of one or more programs within the local memory, and
the instruction buffer and dependency check circuitry of each processor are adapted to process instructions with substantially maximal efficiency when the one or more programs are coded such that they do not rely on data caching within the processor.

20. The apparatus of claim 19, wherein at least one of:
each processor is operable to transfer the blocks of data between the shared memory and its local memory using direct memory accesses; and
the main processor is operable to transfer the blocks of data between the shared memory and the cache memory using direct memory accesses.

21. The apparatus of claim 19, wherein the main processor, the processors, and the local memories are disposed on a common semiconductor substrate.

22. The apparatus of claim 19, further comprising the shared memory coupled to the main processor and the processors over a bus.

23. The apparatus of claim 22, wherein the main processor, the processors, the associated local memories, and the shared memory are disposed on a common semiconductor substrate.

24. The apparatus of claim 19, wherein the local memory is not a hardware cache memory.

25. A method, comprising:
transferring blocks of data between a shared memory and one or more of a plurality of parallel processors, each processor including a local memory;
executing one or more programs within the local memory of one or more of the processors, wherein the one or more programs are coded such that they do not rely on data caching within the processor; and
buffering not more than about three instructions from any local memory in any instruction buffer of any processor.

26. The method of claim 25, wherein the instruction buffer of each processor is adapted to process instructions with substantially maximal efficiency when the one or more programs are coded such that they do not rely on data caching within the processor.

27. The method of claim 25, further comprising dispatching all the instructions from the instruction buffer as a group.

28. The method of claim 25, further comprising simultaneously decoding all of the instructions from the instruction buffer.

29. The method of claim 25, further comprising checking dependencies of the instructions in parallel.

30. The method of claim 25, wherein the one or more programs cannot be executed within the shared memory.

31. A method, comprising:
transferring blocks of data between a shared memory and one or more of a plurality of parallel processors, each processor including a local memory;
transferring blocks of data between the shared memory and at least one main processor, the at least one main processor being coupled to a hardware cache memory for storing the blocks of data;
executing one or more programs within the local memory of one or more of the processors, wherein the one or more programs are coded such that they do not rely on data caching within the processor; and
buffering not more than about three instructions from any local memory in any instruction buffer of any processor.

32. The method of claim 31, wherein the main processor, the processors, and the local memories are disposed on a common semiconductor substrate.

33. The apparatus of claim 32, wherein the main processor, the processors, the associated local memories, and the shared memory are disposed on a common semiconductor substrate.

34. A storage medium containing a software program, the software program being operable to cause a processor to execute actions including:
transferring blocks of data between a shared memory and one or more of a plurality of parallel processors, each processor including a local memory;
executing one or more programs within the local memory of one or more of the processors, wherein the one or more programs are coded such that they do not rely on data caching within the processor; and
buffering not more than about three instructions from any local memory in any instruction buffer of any processor.
